(19) United States
(12) Patent Application Publication
(10) Pub. No.: US 2024/0384767 A1
(43) Pub. Date: Nov. 21, 2024

(54) PAD LINER AND BRAKE DEVICE EQUIPPED WITH THE PAD LINER

(71) Applicant: HYUNDAI MOBIS CO., LTD., Seoul (KR)

(72) Inventors: Kang Kuk LEE, Seongnam-si (KR); Se Jin PARK, Yongin-si (KR); Wan Kyu LEE, Yongin-si (KR); In Ho LEE, Anyang-si (KR)

(73) Assignee: HYUNDAI MOBIS CO., LTD., Seoul (KR)

(21) Appl. No.: 18/511,053

(22) Filed: Nov. 16, 2023

(30) Foreign Application Priority Data
May 17, 2023 (KR) 10-2023-0063576

(51) Int. Cl. F16D 55/228; F16D 65/00; F16D 65/097

(52) U.S. Cl. CPC F16D 55/228; F16D 65/0068; F16D 65/0972; F16D 65/0977; F16D 2055/0016; F16D 65/183; F16D 2127/02

(57) ABSTRACT

A brake device includes an opposing-type caliper body, brake pads mounted in the caliper body, each pad liner that supports the brake pads, and each pad pusher that pushes each brake pad, wherein the brake pad includes protrusions protruding from both side surfaces thereof, wherein the caliper body includes each guide groove defined therein to guide each protrusion, wherein the brake pad moves guided by the guide grooves. The caliper body is of a mono block type.

### CROSS-REFERENCE TO RELATED APPLICATION

This application claims the benefit of Korean Patent Application No. 10-2023-0063576, filed on May 17, 2023, which is hereby incorporated by reference as if fully set forth herein.

### TECHNICAL FIELD

The present embodiments relate to a brake device and a pad liner equipped with a brake that may be applied to vehicles in all fields.

### BACKGROUND

A brake device mounted on a vehicle is a device for decelerating or stopping the vehicle while driving, or maintaining a stopped state of the vehicle, and brakes the vehicle by strongly pressing a disc-shaped brake disc that rotates along with a wheel of the vehicle with brake pads from both sides.

The brake device is supported in a state in which the two brake pads disposed on both sides of the brake disc are able to move forward and backward within a caliper body (a housing). Pad guide pins that respectively guide the forward and backward movement of the brake pads, and spring members that elastically support upper portions of two pad plates to prevent the pad plates from shaking and allow a smooth return operation to be performed, respectively, may be disposed on the two brake pads. Additionally, a pad liner that supports respective feet of the two brake pads on one of both sides may be disposed.

The brake device requires components mounted in the body, such as the brake pad and a pad pusher, to be accurately assembled in place. An assembly process of disposing the components in a limited space is quite difficult. The level of difficulty during the assembly may vary depending on a type of brake device. When the body is of an opposing type, an opening through which the component may enter the inside of the body is limited, making the assembly difficult. This is especially true when the body is of a mono block type in which the body is formed in one piece and is difficult to be removed.

In the case of the opposing-type caliper body, a piston, the pad liner, and/or the brake pad are installed inside the caliper body via the opening of the caliper body. In this regard, a general process is that the pad liner is mounted first and then the brake pad is mounted, but a shape of the pad liner is complex, so that it is not easy to insert the brake pad into the caliper body. Ultimately, the difficulty of assembling the brake device requires a worker to assemble the components one by one, which reduces productivity of the brake device.

Therefore, there is a need for improved technology with such problems reduced.

### SUMMARY

Embodiments of the present disclosure are to provide a brake device with improved ease of assembly and a pad liner mounted therein.

In addition, embodiments of the present disclosure are to provide a brake device with improved drag performance and noise performance during braking by securing a return force of a brake pad, and a pad liner mounted therein.

Additionally, embodiments of the present disclosure are to provide a brake device with reduced production costs and a pad liner mounted therein.

Problems to be solved in the present disclosure are not limited to the problems mentioned above, and other problems not mentioned will be clearly understood by those skilled in the art in the technical field to which the present disclosure belongs from the description below.

A brake device according to an embodiment of the present disclosure includes an opposing-type caliper body, brake pads mounted in the caliper body, each pad liner that supports the brake pads, and each pad pusher that pushes each brake pad, the brake pad includes protrusions protruding from both side surfaces thereof, the caliper body includes each guide groove defined therein to guide each protrusion, and the brake pad moves guided by the guide grooves. The caliper body may be of a mono block type.

The pad liner may include a flat plate-type upper body with legs extending downwards, a pad support connected to a lower end of each leg to support the protrusion of each brake pad, and a lower body connected to a lower end of the pad support, and the upper body may include a hooking protrusion engaged with a portion of the caliper body.

The pad support may include an upper plate connected to the lower end of the leg and adjacent to a top surface of the protrusion, a side plate connected to and extending downwards from the upper plate and adjacent to a side surface of the protrusion, and a lower plate connected to a lower end of the side plate and adjacent to a bottom surface of the protrusion, the lower plate may be convex upwards to support the protrusion, and a guide space where the protrusion is guided may be defined by the upper plate, the side plate, and the lower plate.

In addition, the pad support may further include a return spring forming an inclination at a predetermined angle from an inner edge of one of the upper plate, the side plate, and the lower plate and extending outwards within the guide space.

In addition, the protrusion may include a first inclined surface formed along one of an upper edge, a lower edge, and an outer edge of a front surface thereof corresponding to the return spring.

The protrusion may include a second inclined surface formed along an upper edge of a rear surface thereof, and a third inclined surface formed along a lower edge of the rear surface thereof.

An end of the return spring may support the first inclined surface of the protrusion, and the end of the return spring may include a curved surface formed by being bent in a rearward direction of the pad liner.

In addition, at least one of the upper body, the lower body, and the side plate may include a reinforcement portion extending forwards from an outer edge of the pad liner.

A pad liner mounted in a brake device including brake pads, according to an embodiment of the present disclosure includes a flat plate-type upper body with legs extending downwards, a pad support connected to a lower end of the leg to support a protrusion of the brake pad, and a lower body connected to a lower end of the pad support and extending downwards, the upper body includes a hooking protrusion engaged with a caliper body of the brake device, and the lower body is not in contact with a lower end of the brake pad.

According to the embodiment of the present disclosure, the assembly performance of the brake device may be increased. For example, the process of assembling the brake pad after assembling the pad liner is much easier.

In addition, the reliability of the return operation of the brake pad is ensured, thereby reducing the drag and the braking noise.

In addition, the brake pad and the caliper body are easily detached from each other, making the maintenance and the repair of the brake caliper easy.

Effects to be solved in the present disclosure are not limited to the effects mentioned above, and other problems not mentioned will be clearly understood by those skilled in the art in the technical field to which the present disclosure belongs from the description below.

### BRIEF DESCRIPTION OF THE DRAWINGS

FIG. 1A is a perspective view of a brake device according to an embodiment of the present disclosure.

FIG. 1B is a top plan view of a brake device.

FIG. 1C is a bottom plan view of a brake device.

FIG. 2 is an exploded perspective view of a brake device.

FIG. 3A shows a cross-section A-A of a caliper body in FIG. 2.

FIG. 3B shows a cross-section B-B of a caliper body in FIG. 2.

FIG. 4A is a perspective view of a brake pads.

FIG. 4B is an enlarged view of a side surface of a protrusion of a brake pad.

FIG. 4C shows a protrusion in FIG. 4B from below.

FIG. 5A is a perspective view of a pad liner according to an embodiment of the present disclosure.

FIG. 5B is a side view of a pad liner.

FIG. 5C shows a section C-C in FIG. 5B.

FIG. 6 shows an assembly process of a pad liner and a brake pad.

FIG. 7 shows an interaction between a pad liner and a brake pad.

### DESCRIPTION OF SPECIFIC EMBODIMENTS

Advantages and features of the present disclosure, and a method for achieving the same, will become apparent with reference to the embodiments described below in detail in conjunction with the accompanying drawings. However, the present disclosure may not be limited to the embodiments disclosed below, but may be implemented in a variety of different forms. The present embodiments are provided only to ensure that the disclosure of the present disclosure is complete, and to completely inform those skilled in the art to which the present disclosure belongs, the scope of the present disclosure. The present disclosure is only defined by the scope of the claims.

The terminology used herein is for the purpose of describing the embodiments only and is not intended to limit the present disclosure. As used herein, the singular forms “a” and “an” are intended to include the plural forms as well, unless the context clearly indicates otherwise. As used herein, “comprises” and/or “comprising” do not exclude the presence or addition of one or more other components in addition to a stated component. Like reference numerals refer to like components throughout the specification, and “and/or” includes each of the mentioned components and every combination of one or more of the components. Although “first”, “second”, and the like are used to describe various components, it is apparent that such components are not limited by such terms. Such terms are only used to distinguish one component from another. Accordingly, it is apparent that the first component mentioned below may be the second component within the technical spirit of the present disclosure.

Unless otherwise defined, all terms including technical and scientific terms used herein have the same meaning as commonly understood by one of ordinary skill in the art to which the present disclosure belongs. In addition, terms defined in a commonly used dictionary are not to be interpreted ideally or excessively unless specifically defined explicitly.

Spatially relative terms “below”, “beneath”, “lower”, “above”, “upper”, and the like may be used to easily describe a correlation between one component and other components as shown in the drawings. Spatially relative terms should be understood as terms including different directions of the components during use or operation in addition to directions shown in the drawings. For example, when a component shown in the drawings is flipped, a component described as being located “below” or “beneath” another component may be placed “above” said another component. Accordingly, the exemplary term “below” may include both downward direction and upward direction. Components may also be oriented in other directions, and thus, spatially relative terms may be interpreted based on the orientation.

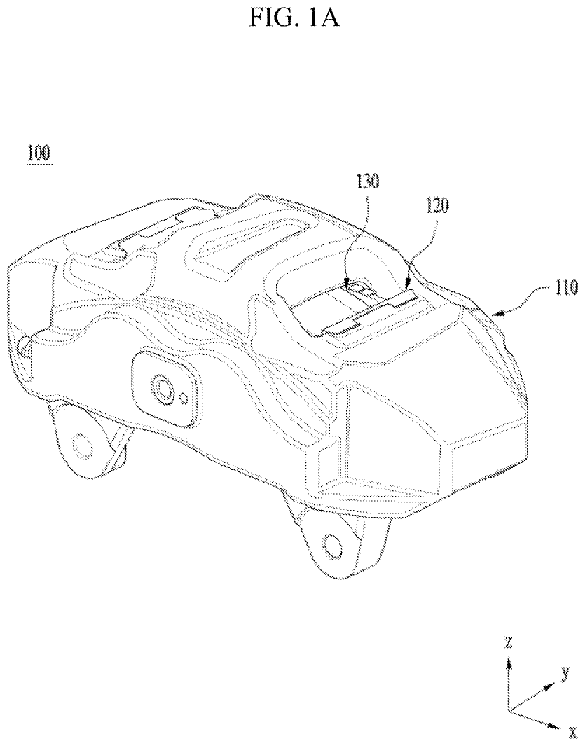

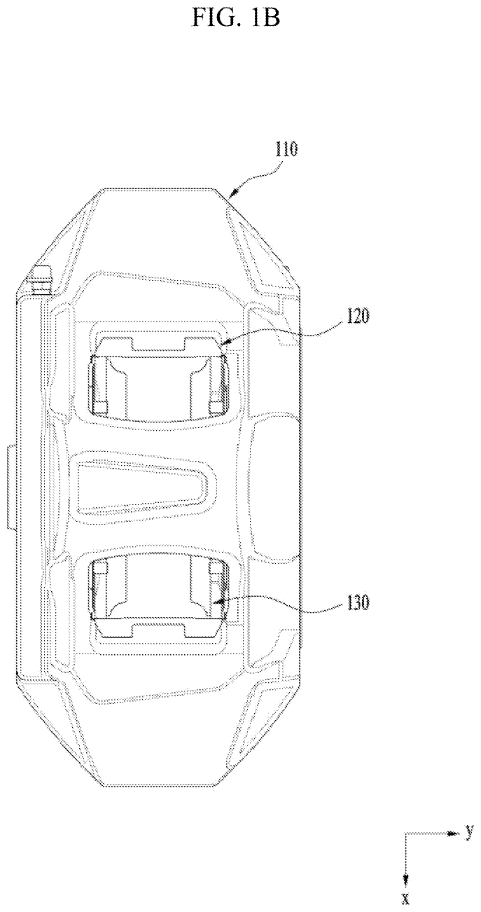

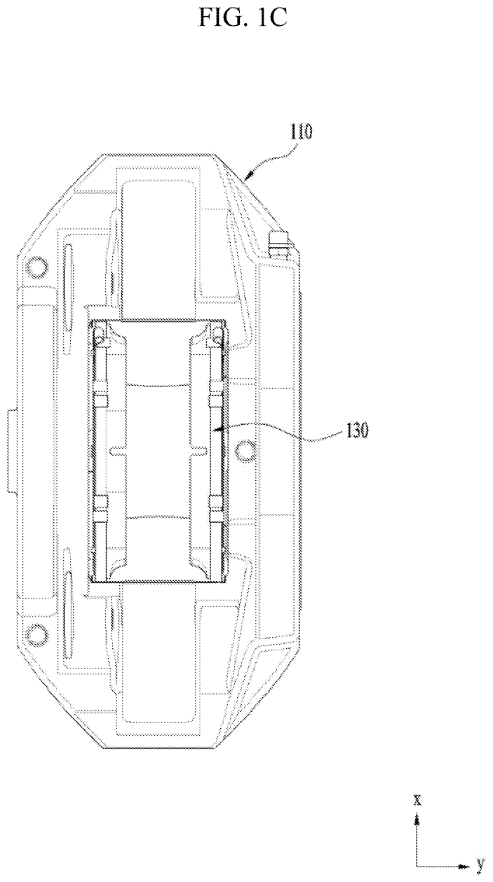

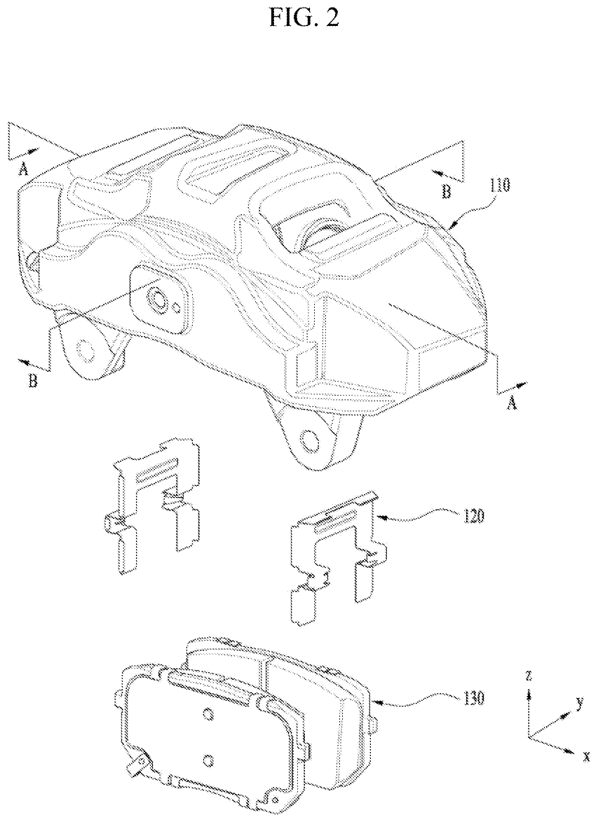

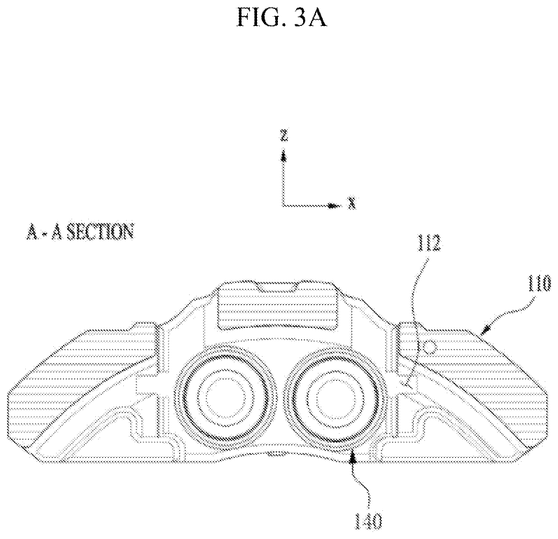

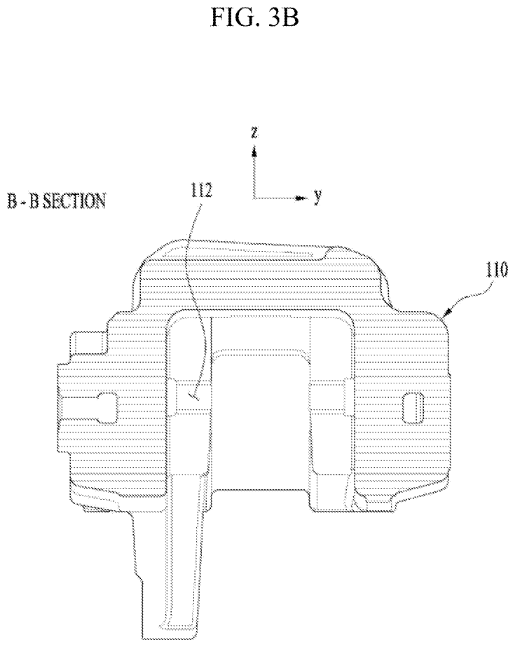

FIG. 1A is a perspective view of a brake device 100 (hereinafter, referred to as a ‘brake device’) according to an embodiment of the present disclosure. FIG. 1B is a top plan view of the brake device 100, and FIG. 1C is a bottom plan view of the brake device 100. FIG. 2 is an exploded perspective view of the brake device 100. FIG. 3A shows a cross-section A-A of the caliper body 110 in FIG. 2, and FIG. 3B shows a cross-section B-B of the caliper body 110 in FIG. 2. FIGS. 3A and 3B show the interior of the caliper body 110.

With reference to FIGS. 1A to 1C and FIG. 2, the brake device 100 includes a caliper body 110, brake pads 130, and pad liners 120.

The caliper body 110 is a body that may accommodate the components of the brake device 100 therein. The caliper body 110 includes an internal space in which the components may be mounted, and includes an opening connected from the outside to the internal space. Accordingly, the components connected to the internal space of the caliper body 110 may enter the internal space and be assembled via the opening.

The caliper body 110 is of an opposing type. The components such as the brake pads 130, pad pushers 140, and the like adjacent to both side surfaces of a brake disc (not shown) may be connected to the inside of the caliper body 110. The pair of brake pads 130 may be connected to the pad pushers 140, respectively, and may be pushed by power transmitted from the respective pad pushers 140. A first brake pad that presses one side surface of the brake disc, and a second brake pad that presses the other side surface thereof may be pushed by the (hydraulic or motor-operated) pad pushers 140, respectively, to press both side surfaces of the brake disc.

Additionally, the caliper body 110 may be of a mono block type in which the entire body is formed as one piece. In the drawing, the mono block-type caliper body 110 is shown. As shown, the opening may be defined in a bottom of the caliper body 110, and the components may be assembled inside the caliper body 110 via the opening.

Referring to FIGS. 3A and 3B, the brake device 100 includes the pad pusher 140 that pushes the brake pad 130. The pad pusher 140 is seated in an accommodating space within the caliper body 110, and the pad pusher 140 includes a piston and components for pushing the piston. For example, the pad pusher 140 may be based on a hydraulic or motor-operated component. As an example of the motor-operated component, the pad pusher 140 may include a ball screw structure or other actuator that pushes the brake pad 130 based on a motor.

The caliper body 110 includes a guide groove 112 to guide a moving direction of the brake pad 130. The guide grooves 112 may be defined at a total of four locations to guide protrusions 132 formed at both sides of each of the pair of brake pads 130. Specifically, the guide grooves 112 may guide the protrusions 132 protruding at both sides of the brake pad 130 in a straight direction (a direction parallel to a y-axis). Accordingly, the brake pad 130 may move while the protrusions 132 are guided by the caliper body 110. The guide groove 112 of the caliper body 110 extends parallel to the moving direction of the brake pad 130.

A material and a shape of the caliper body 110 may be variously determined in consideration of locations, loads, and the like of other components. Preferably, the material of the caliper body 110 includes a metal-based material. The caliper body 110 may be made of a metal-based material with appropriate strength to support a reaction force against a braking clamping force. The caliper body 110 may be connected to a fixed component such as a knuckle (not shown) of a vehicle wheel.

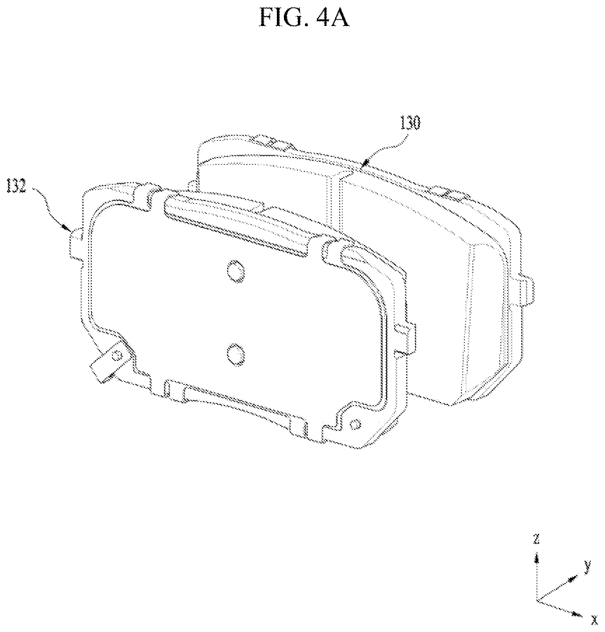

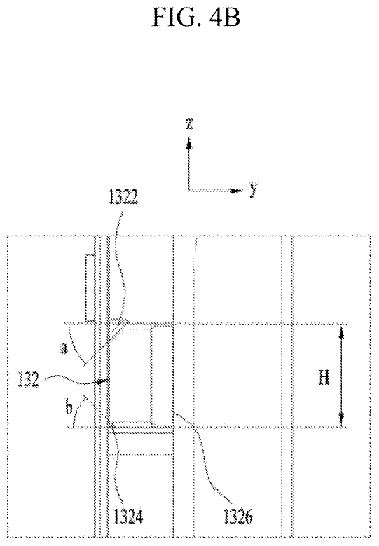

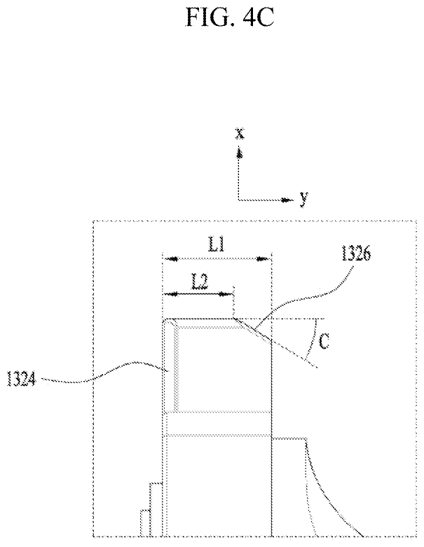

FIG. 4A is a perspective view of the brake pads 130, and FIG. 4B is an enlarged view of a side surface of the protrusion 132 of the brake pad 130. FIG. 4C shows the protrusion 132 in FIG. 4B from below. The protrusion 132 shown in detail in FIGS. 4B and 4C may be one of the protrusions 132 of the brake pad 130 shown in FIG. 4A.

The brake pad 130 may be composed of a pad that comes in direct contact with and rubs against the brake disc and a back plate connected to one surface of the pad. The plurality of brake pads 130 may be arranged, with a first brake pad being disposed in the caliper body 110 to pressurize one side surface of the brake disc and a second brake pad being disposed in the caliper body 110 to pressurize the other side surface of the brake disc. That is, the pair of brake pads 130 may be arranged with pad surfaces thereof facing each other with the brake disc therebetween.

The brake pad 130 includes the protrusions 132 that protrude outward from both side surfaces of the back plate. The protrusion 132 may be inserted into the aforementioned guide groove 112 of the caliper body 110, and thus, a direction of the forward and backward movement of the brake pad 130 may be guided.

FIG. 4B is a side view of the protrusion 132 of the brake pad 130. In describing the components of the brake pad 130, ‘front’ refers to a direction aligned with the pad surface of the brake pad 130 facing forward, and ‘rear’ refers to a direction opposite thereto. A front surface represents a surface facing forward, and a rear surface represents a surface facing rearward.

Referring to FIG. 4B, the protrusion 132 may include an inclined surface at a front edge (or corner) of a side surface thereof. Additionally, inclined surfaces may be included at rear edges (or corners) of top and rear surfaces of the protrusion 132.

Specifically, the protrusion 132 includes a first inclined surface 1326 formed along an outer edge (or corner) of a front surface thereof. Additionally, the protrusion 132 includes a second inclined surface 1322 formed along an upper edge (or corner) of the rear surface thereof, and a third inclined surface 1324 formed along a lower edge (or corner) of the rear surface thereof.

The first inclined surface 1326 is inclined with respect to the front and side surfaces of the protrusion 132, the second inclined surface 1322 is inclined with respect to the top and rear surfaces of the protrusion 132, and the third inclined surface 1324 is inclined with respect to the bottom and rear surfaces of the protrusion 132.

An angle ‘a’ shown in FIG. 4B represents the angle formed by the second inclined surface 1322 with the top surface of the protrusion 132. The angle ‘a’ is smaller than 90 degrees. Preferably, the angle ‘a’ may be equal to or smaller than 60 degrees.

An angle ‘b’ shown in FIG. 4B represents the angle formed by the third inclined surface 1324 with the bottom surface of the protrusion 132. The angle ‘b’ is smaller than 90 degrees. Preferably, the angle ‘b’ may be equal to or smaller than 60 degrees.

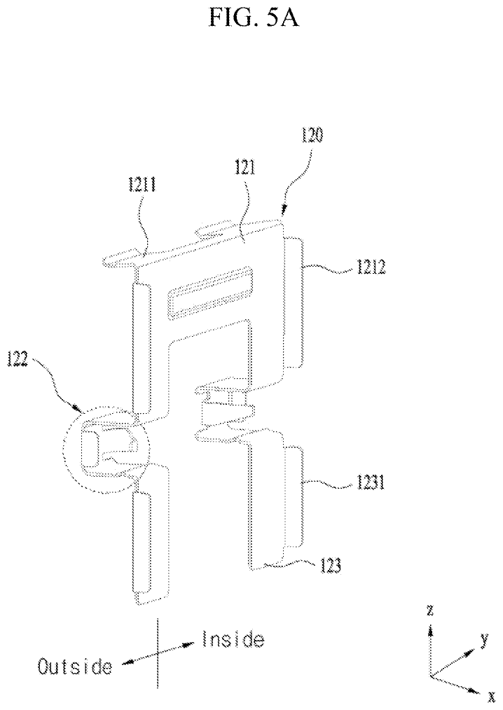

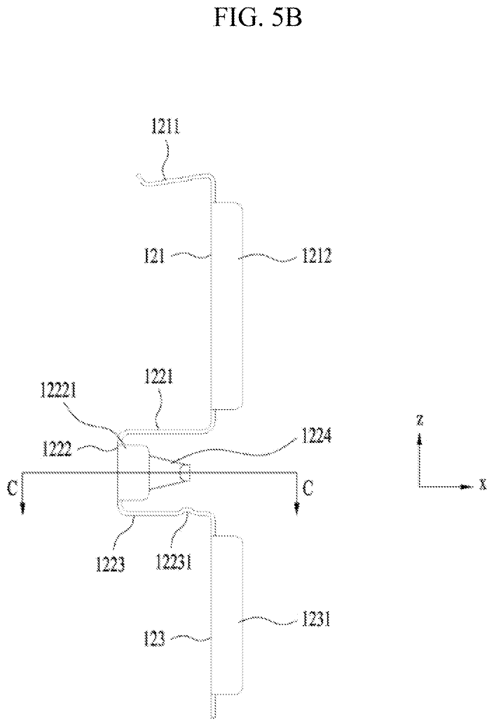

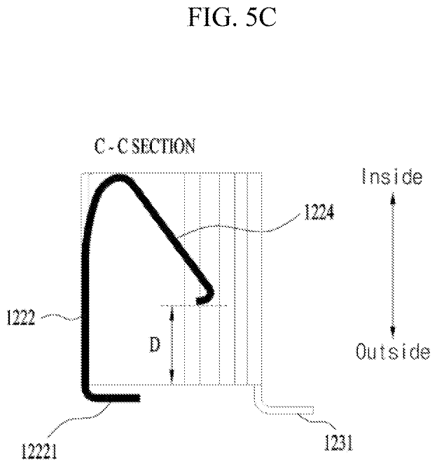

Lengths of inclination of the second inclined surface 1322 and the third inclined surface 1324 may be appropriately changed by a person skilled in the art. The second inclined surface 1322 and the third inclined surface 1324 may serve as a guide for the protrusion 132 of the brake pad 130 to be easily inserted when being inserted into an internal space of a pad support 122 (which will be described in FIGS. 5A to 5C) of the pad liner 120. Accordingly, the inclination angles, the inclination lengths, and the like of the second inclined surface 1322 and the third inclined surface 1324 may be changed by a person skilled in the art for the purpose of appropriately performing the above role.

FIG. 4C is a bottom view of the protrusion 132 in FIG. 4B. An angle ‘c’ shown in FIG. 4C represents an angle formed between the first inclined surface 1326 and the side surface of the protrusion 132. The angle ‘c’ is smaller than 90 degrees. An inclination angle and an inclination length of the first inclined surface 1326 are based on a return spring 1224 of the pad support 122 (which will be described in FIGS. 5A to 5C). A thickness L1 of the protrusion 132 is smaller than a width of the pad support 122 and is greater than the smallest distance ‘D’ between a virtual surface including an outer edge (or corner) of the pad support 122 and an end of the return spring 1224. L2 represents a distance from the rear edge of the side surface of the protrusion 132 to the first inclined surface 1326. The L2 is smaller than the smallest distance ‘D’ between the virtual surface including the outer edge (or corner) of the pad support 122 and the end of the return spring 1224. Therefore, the end of the return spring 1224 may be in contact with the first inclined surface 1326 and support the protrusion 132.

In another embodiment, the first inclined surface may be an inclined surface formed along an upper or lower edge of the front surface of the protrusion. A location where the return spring is formed may be changed based on the location where the first inclined surface is formed. For example, when the first inclined surface is formed at the upper edge of the front surface of the protrusion, the return spring may be formed extending from an inner edge of an upper plate of the pad support. Additionally, when the first inclined surface is formed at the lower edge of the front surface of the protrusion, the return spring may be formed extending from an inner edge of a lower plate of the pad support.

FIG. 5A is a perspective view of the pad liner 120 according to an embodiment of the present disclosure. FIG. 5B is a side view of the pad liner 120. In describing the pad liner 120, ‘front’ refers to an x-axis direction in FIG. 5A, and ‘rear’ refers to a direction opposite thereto. ‘Upper’ represents a z-axis direction, and ‘lower’ represents to a direction opposite thereto. The pad liner 120 will be described based on the directions shown in FIG. 5A.

As shown in FIGS. 1B and 2, the plurality of pad liners 120 may be disposed on both sides of the brake pad 130, respectively. One pad liner 120 may support one side of the pair of brake pads 130.

Referring to FIGS. 5A and 5B, the pad liner 120 includes an upper body 121, the pad support 122, and a lower body 123. The upper body 121 is a flat plate standing parallel to the z-axis direction and has legs extending downward. Specifically, the upper body 121 may have two legs extending downward. The two legs are spaced apart from each other, and each leg are able to support one of the pair of brake pads facing each other. In other words, the pad liner 120 supports both the protrusion of the first brake pad and the protrusion of the second brake pad.

The upper body 121 includes a hooking protrusion 1211. The hooking protrusion 1211 is connected to an upper edge of the upper body 121 and forms a predetermined angle with the upper body 121. In this regard, the predetermined angle may be equal to or smaller than 90 degrees. The hooking protrusion 1211 is a component that is engaged with one portion of the caliper body 110 such that the pad liner 120 is fixed to a specific location inside the caliper body 110. Accordingly, a shape of the stopping protrusion 1211 may correspond to an internal shape of the caliper body 110.

The pad support 122 is connected to a lower end of the leg of the upper body 121 and supports the protrusion 132 of the brake pad 130. The pad support 122 may include an upper plate 1221, a side plate 1222, and/or a lower plate 1223.

The upper plate 1221 is a flat plate connected to the lower end of the leg of the upper body 121 and extending rearwards, and is adjacent to the top surface of the protrusion 132. The side plate 1222 is a flat plate connected to a rear edge (or corner) of the upper plate 1221 and extending downwards, and is adjacent to the side surface of the protrusion 132. The lower plate 1223 is a flat plate connected to a lower end of the side plate 1222 and extending forwards, and is adjacent to the bottom surface of the protrusion 132.

The pad support 122 defines a guide space where the upper plate 1221, the side plate 1222, and the lower plate 1223 may guide the protrusion 132. As the protrusion 132 is inserted into the guide space of the pad support 122, the brake pad 130 may be guided.

The pad support 122 further includes the return spring 1224.

FIG. 5C shows a section C-C in FIG. 5B. Referring to FIG. 5C, the return spring 1224 extends from an inner edge of the side plate 1222, is inclined at a predetermined angle with the side plate 1222, and extends in an outward direction within the guide space.

The end of the return spring 1224 may support the first inclined surface 1326 of the protrusion 132, and the end of the return spring 1224 may include a curved surface formed by being bent in a rearward direction of the pad liner 120. Therefore, the curved surface formed at the end of the return spring 1224 may be in contact with the first inclined surface 1326 of the protrusion 132 and apply a return force to the brake pad 130, and reduce frictional resistance resulted from the contact.

As another embodiment, the return spring may extend from the inner edge of the upper plate 1221 or the lower plate 1223, form an incline at a predetermined angle with the upper plate 1221 or the lower plate 1223, and extend outwards within the guide space. In this case, the first inclined surface corresponding to the return spring may also be formed at the upper or lower end of the front surface of the protrusion.

Referring to FIG. 5C, the distance ‘D’ represents the smallest distance from the end of the return spring 1224 to the virtual surface including an outer edge of the pad support 122. The distance ‘D’ is greater than L2 and smaller than L1 illustrated in FIG. 4C. A length, an angle, and the like of the return spring 1224 may be appropriately changed by a person skilled in the art within a range that satisfies the above-mentioned conditions.

Because of the above-described configuration, the end of the return spring 1224 comes into contact with the first inclined surface 1326. When the brake pad 130 is pushed, the protrusion 132 moves in an inward direction of the pad liner 120, and at this time, elasticity of the modified return spring 1224 pushes the protrusion 132 outwards and applies the return force such that the brake pad 130 returns.

When removing the brake pad 130 from the caliper body 110, the brake pad 130 may be easily removed by being pushed in the inward direction of the pad liner 120. The brake pad 130 may be removed without applying an additional force to the return spring 1224 and deforming the same.

When assembling the brake pad 130, the protrusion 132 moves from the inside to the outside of the pad liner 120 and is inserted into the guide space of the pad support 122. In this regard, the return spring 1224 is compressed to the rear of the pad liner 120 by the entering protrusion 132. Then, when the protrusion 132 completely enters, the return spring 1224 returns to an original state thereof and the end thereof comes into contact with the first inclined surface 1326 of the protrusion 132. Therefore, when assembling the brake pad 130, no additional force is applied to the return spring 1224, so that the brake pad 130 may be easily assembled.

The lower plate 1223 of the pad support 122 includes a support 12231 that is formed to be upwardly convex to support the protrusion 132. The support 12231 may be formed as a partial area of the lower plate 1223 protrudes in a convex shape. The support 12231 may minimize a clearance resulted from a difference between vertical dimensions of the guide space and the protrusion 132, and thus, eliminate noise generated when the brake pad 130 moves because of the clearance.

The lower body 123 of the pad liner 120 is a flat plate extending downwards from a front edge (or corner) of the lower plate 1223. That is, the lower body 123 may be connected to a lower end of the pad support 122. Additionally, the lower body 123 may be formed in a direction parallel to the upper body 121.

Preferably, the lower body 123 is not in contact with a lower end of the brake pad 130. Specifically, the lower body 123 does not support a foot load of the brake pad 130. Additionally, the lower body 123 does not include any other components in contact with the lower end of the brake pad 130. Because of such configuration of the lower body 123, when the brake pad 130 moves into the caliper body 110, interfering elements in an entry path may be eliminated.

The upper body 121, the pad support 122, and the lower body 123 of the pad liner 120 may correspond to a shape of a wall formed inside the caliper body 110, and the pad liner 120 may be seated inside the caliper body 110.

Additionally, at least one of the upper body 121, the lower body 123, and the side plate 1222 may further include a reinforcement portion extending forward from an outer edge thereof. Reinforcement portions 1212, 12221, and 1231 reinforce rigidity of the upper body 121, the lower body 123, and/or the side plate 1222. Widths, lengths, and the like of the reinforcement portions may be appropriately changed by a skilled engineer considering the rigidity of the respective components.

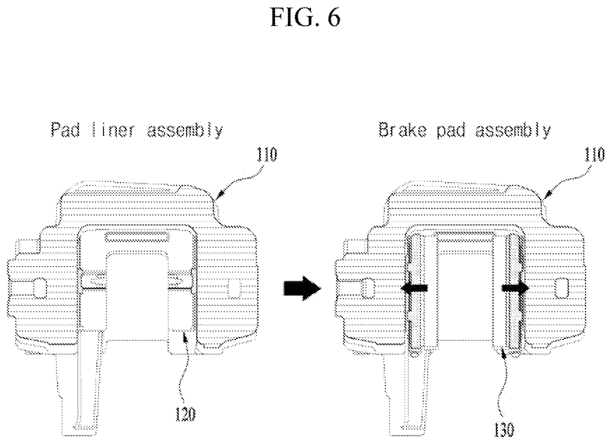

FIG. 6 shows an assembly process of the pad liner 120 and the brake pad 130. To illustrate the inside of the caliper body 110, the cross-section B-B in FIG. 2 is shown. Referring to FIG. 6, the pad liner 120 enters the inside via the bottom opening of the caliper body 110 and is disposed such that the pad support 122 is inserted into the guide groove 112 defined inside the caliper body 110. After the pad liner 120 is assembled, the brake pad 130 enters from below via the opening of the caliper body 110. In addition, when the protrusion 132 of the brake pad 130 is inserted into the guide space of the pad support 122 and pushed from the inside to the outside, the brake pad 130 is assembled. During the assembly of the brake pad 130, the return spring 1224 supports the first inclined surface 1326 of the protrusion 132 while being compressed and then restored.

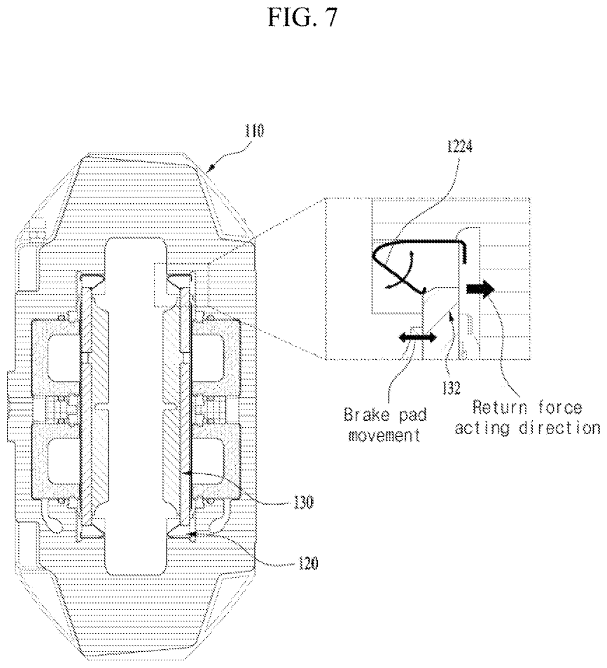

FIG. 7 shows an interaction between the pad liner 120 and the brake pad 130. Referring to FIG. 7, a direction in which the brake pad 130 moves forward and backward by the pad pusher 140 is shown. In addition, a direction in which the return spring 1224 exerts the return force on the brake pad 130 in such process is shown. When the brake pad 130 moves forward, deformation of the return spring 1224 occurs, and the return force is applied to the brake pad 130 because of the elasticity of the return spring 1224. When an external force is applied to the brake pad 130 to move and remove the same, the return spring 1224 may be compressed while being pressed along the first inclined surface 1326, and the brake pad 130 may be removed in the inward direction of the pad liner 120.

The brake device according to an embodiment of the present disclosure may automate the assembly of the pad liner and the brake pad for the opposing-type brake device. Improved assembly of the brake device leads to improved productivity, and reduces a cost of the brake device. In addition, the brake pad may be easily removed, which is advantageous in a maintenance and repair process of the brake device.

The brake device effectively reduces drag and braking noise using a reinforced return structure during a braking operation of the vehicle. As the return force is applied symmetrically to both side surfaces of the brake pad, the entire brake pad may move evenly.

It is understood that the description of the various embodiments of the present disclosure is not limited only to the corresponding embodiments, and the technical ideas of the respective embodiments may also be applied to other embodiments.

As described above, the detailed description of the preferred embodiments of the present disclosure is provided such that those skilled in the art may implement and practice the present disclosure. Although the description has been made above with reference to the preferred embodiments of the present disclosure, those skilled in the art will understand that the present disclosure may be modified and changed in various ways within a range that does not deviate from the scope of the present disclosure. For example, those skilled in the art may use the respective components described in the above-described embodiments in a way of combining them to each other.

Thus, the present disclosure is not intended to be limited to the embodiments illustrated herein but is to be accorded the widest scope consistent with the principles and novel features disclosed herein.

What is claimed is:

1. A brake device comprising:
a caliper body;
brake pads mounted in the caliper body;
a pad liner configured to support the brake pads; and
a pad pusher configured to push each of the brake pads, wherein each of the brake pads includes protrusions protruding from both side surfaces thereof,
wherein the caliper body includes guide grooves defined therein to guide the protrusions, respectively,
wherein the brake pad are movable by being guided by the guide grooves.

2. The brake device of claim 1, wherein the caliper body is of a mono block type.

3. The brake device of claim 1, wherein the pad liner includes:
a flat plate-type upper body with legs each extending downwards;
a pad support connected to a lower end of each leg to support one of the protrusions of each brake pad; and
a lower body connected to a lower end of the pad support,
wherein the upper body includes a hooking protrusion engaged with a portion of the caliper body.

4. The brake device of claim 3, wherein the pad support includes:
an upper plate connected to the lower end of each leg and adjacent to a top surface of the corresponding protrusion;
a side plate connected to and extending downwards from the upper plate and adjacent to a side surface of the protrusion; and
a lower plate connected to a lower end of the side plate and adjacent to a bottom surface of the protrusion,
wherein the lower plate is convex upwards to support the protrusion,
wherein a guide space where the protrusion is guided is defined by the upper plate, the side plate, and the lower plate of the pad support.

5. The brake device of claim 4, wherein the pad support further includes a return spring forming an inclination at a predetermined angle from an inner edge of one of the upper plate, the side plate, and the lower plate and extending outwards within the guide space.

6. The brake device of claim 5, wherein each of the protrusions includes a first inclined surface formed along one of an upper edge, a lower edge, and an outer edge of a front surface thereof corresponding to the return spring.

7. The brake device of claim 6, wherein each of the protrusions further includes:
a second inclined surface formed along an upper edge of a rear surface thereof; and
a third inclined surface formed along a lower edge of the rear surface thereof.

8. The brake device of claim 7, wherein an end of the return spring supports the first inclined surface of the corresponding protrusion,
wherein the end of the return spring includes a curved surface formed by being bent in a rearward direction of the pad liner.

9. The brake device of claim 8, wherein at least one of the upper body, the lower body, or the side plate includes a reinforcement portion extending forwards from an outer edge of the pad liner.

10. A pad liner mounted in a brake device including brake pads, the pad liner comprising:
a flat plate-type upper body with legs each extending downwards;
a pad support connected to a lower end of the corresponding leg to support a protrusion of each of the brake pads; and
a lower body connected to a lower end of the pad support and extending downwards,
wherein the upper body includes a hooking protrusion engaged with a caliper body of the brake device,
wherein the lower body is spaced apart from a lower end of the brake pad.
